(19) United States
(12) Patent Application Publication
(10) Pub. No.: US 2008/0214728 A1
(43) Pub. Date: Sep. 4, 2008

(54) One-Component Polyurethane Systems that are Devoid of Metal

(75) Inventors: Emmanouil Spyrou, Schermbeck (DE); Volker Weiss, Haltern am See (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Evonik Degussa GmbH, Essen (DE)

(21) Appl. No.: 12/088,949

(22) PCT Filed: Oct. 13, 2006
(86) PCT No.: PCT/EP2006/067391

§ 371 Date: Apr. 2, 2008

(30) Foreign Application Priority Data
Oct. 21, 2005 (DE) 102005050525.2

(51) Int. Cl. C08G 18/16

(52) U.S. Cl. 524/590; 528/45

(57) ABSTRACT

The invention relates to metal-free one-component polyurethane systems.

The invention relates to metal-free one-component (1K) polyurethane systems.

Catalyzed one-component polyurethane systems are well established. They are described at length for example in the review article by D. A. Wicks and Z. Wicks entitled “Blocked isocyanates III A: Mechanism and chemistry” in Progress in Organic Coatings, 36, (1999), 148-172 and also in the references cited therein.

Catalysts are used in these one-component polyurethane systems in order to lower the curing temperature. This saves energy, reduces the temperature exposure of the substrate, and raises the possible cycle time in the coating operation.

There are two major classes of common catalysts. One comprises organometallic compounds, especially organotin catalysts, the best-known among which is dibutyltin dilaurate (DBTL). The reputation of these catalysts is now stained, owing to their toxicological effect, in certain applications (in textile processing, for example). The other group comprises basic amines, such as 1,4-diazabicyclo[2.2.2]octane (Dabco). These catalysts lead to unwanted yellowing, owing to formation of N-oxide.

It was therefore an object to find suitable catalysts for one-component polyurethane systems, said catalysts containing neither metals nor oxidizable amines.

Surprisingly it was possible to achieve this object by means of a catalyst combination comprising quaternary ammonium salts containing alternatively a hydroxide, a fluoride or a carboxylate as counterion, and an acid scavenger.

The invention provides one-component polyurethane systems containing the mixture of
A) at least one blocked aromatic, aliphatic, (cyclo)aliphatic and/or cycloaliphatic polyisocyanate component;
B) at least one monomeric, oligomeric and/or polymeric polyol;
C) at least one quaternary ammonium salt that contains a hydroxide, a fluoride or a carboxylate as counterion, in a concentration of from 0.001% to 3%, based on the total amount of the formulation;
D) at least one acid scavenger, in a concentration of from 0.1% to 5%, based on the total amount of the formulation;
E) optionally further monoalcohols, monoamines or diamines;
F) optionally solvents and/or water;
G) optionally further auxiliaries and additives.

The polyisocyanates used as component A) are those whose isocyanate groups have been partly or totally blocked with a blocking agent. Polyisocyanates of this kind may optionally carry urethane groups, isocyanurate groups, allophanate groups, urea groups and/or biuret groups as well. These polyisocyanates are known in principle and described in many patents, such as DE 27 12 931, DE 29 29 224, DE 22 00 342, DE 196 34 054, EP 0 432 257, U.S. Pat. No. 3,857,818, EP 0 159 117, EP 0 713 871, DE 28 12 252, DE 100 33 097, DE 196 26 886, DE 197 30 670, WO 99/06461 or DE 34 34 881, for example.

Isocyanates used for preparing the polyisocyanate component A) are diisocyanates of aromatic, aliphatic, and (cyclo)aliphatic and/or cycloaliphatic structure. Diisocyanates of this kind are described for example in Houben-Weyl, Methoden der organischen Chemie, volume 14/2, page 61 ff. and J. Liebigs Annalen der Chemie, volume 562, pages 75 to 136. Preference is given to using isophorone diisocyanate (IPDI), hexamethylene diisocyanate (HDI), diisocyanato-dicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), toluidine diisocyanate (TDI) and/or methylenediphenyl diisocyanate (MDI) and also tetramethylxylylene diisocyanate (TMXDI). Very particular preference is given to using IPDI, HDI, and H₁₂MDI.

(Cyclo)aliphatic diisocyanates are adequately understood by the skilled worker as NCO groups attached simultaneously both cyclically and aliphatically, as is the case for isophorone diisocyanate, for example. In contrast cycloaliphatic diisocyanates are understood to be those having only NCO groups attached directly to the cycloaliphatic ring, an example being H₁₂MDI.

The polyisocyanate component A) may be chain-extended with polyols. To prepare the polyisocyanate component A), optionally containing urethane groups, the diisocyanate is reacted with a polyol in a first stage for chain extension. In this procedure, the polyol is metered with intense stirring over the course of 2 to 3 hours into the initial charge of diisocyanate, which is at 100 to 120° C., the metered addition taking place under nitrogen, in the absence of moisture, and in a proportion such that for each OH equivalent of the polyol at least 2 and not more than 8, preferably from 4 to 6, NCO equivalents of the diisocyanate are reacted.

The monomeric diols are for example ethylene glycol, triethylene glycol, butane-1,4-diol, pentane-1,5-diol, hexane-1,6-diol, 3-methylpentane-1,5-diol, neopentyl glycol, 2,2,4(2,4,4)-trimethylhexanediol, and neopentyl glycol hydroxypivalate.

The monomeric triols are for example trimethylolpropane, ditrimethylolpropane, trimethylolethane, hexane-1,2,6-triol, butane-1,2,4-triol, tris(β-hydroxyethyl)isocyanurate, pentaerythritol, mannitol or sorbitol.

Also suitable are oligo esters or polyesters as described under B).

For polyisocyanates which do not contain urethane groups it is possible to commence directly with the second stage.

In the second stage the NCO groups (if desired, those remaining from stage one) are fully blocked with a blocking agent. The reaction can be carried out in bulk (without solvent) or else in the presence of suitable (inert) solvents. It is preferred, however, to operate in bulk. The polyol-diisocyanate adduct (or the polyisocyanate) is admixed at from about 100 to 130° C. with the blocking agent in portions at a rate such that the temperature does not rise above 140° C. After the blocking agent has been added the reaction is taken to completion by heating of the reaction mixture at 130° C. for about 1 to 2 hours. The blocking agent is added in amounts such that from 0.7 to 1.1 mol of blocking agent, preferably 1 mol, is reacted per NCO equivalent of the urethanized diisocyanate (or polyisocyanate). The typical mixing equipment is suitable for the preparation, such as stirred tanks, extruders, intensive kneading assemblies or flow tubes.

Suitable blocking agents for NCO groups include all common compounds which can be eliminated again at temperatures below 200° C., such as methyl ethyl ketoxime, acetone oxime, phenol and phenol derivatives, ε-caprolactam, 1,2,4-triazole, 2,5-dimethylpyrazole, diethyl malonate, ethyl acetoacetate, N-tert-butyl-N-benzylamine or diisopropylamine.

Suitable polyols B) include all polyols typically used in PU chemistry with a molecular weight of at least 32 and containing at least two alcohol groups.

The monomeric diols are for example ethylene glycol, triethylene glycol, butane-1,4-diol, pentane-1,5-diol, hexane-1,6-diol, 3-methylpentane-1,5-diol, neopentyl glycol, 2,2,4(2,4,4)-trimethylhexanediol, and neopentyl glycol hydroxypivalate.

The monomeric triols are for example trimethylolpropane, ditrimethylolpropane, trimethylolethane, hexane-1,2,6-triol, butane-1,2,4-triol, tris(β-hydroxyethyl)isocyanurate, pentaerythritol, mannitol or sorbitol.

Also suitable are polyols which contain further functional groups (oligomers or polymers). In this case the polyols in question are the conventional hydroxyl-containing polyesters, polycarbonates, polycaprolactones, polyethers, polythioethers, polyesteramides, polyurethanes or polyacetals. They possess a number average molecular weight of 134 to 3500.

The polyols are used alone or in mixtures.

The ratio of A) to B) is chosen such that for each free or freed NCO equivalent of A) there is approximately one equivalent of B) that is reactive therewith. The NCO—OH ratio is from 1.5:1 to 0.5:1, preferably from 1.1:1 to 0.9:1.

The catalysts C) are quaternary ammonium salts containing either a hydroxide, a fluoride or a carboxylate as counterion.

Examples of suitable catalysts include tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and tetrabutylammonium benzoate, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride, and benzyltrimethylammonium fluoride.

Reactive, acid-scavenging compounds D) are common knowledge in coatings chemistry. For example, epoxy compounds, carbodiimides, hydroxyalkyl amides or 2-oxazolines, but also inorganic salts, such as hydroxides, hydrogencarbonates or carbonates, react with acid groups at elevated temperatures. Suitable examples in this case include triglycidyl ether isocyanurate (TGIC), EPIKOTE® 828 (diglycidyl ether based on bisphenol A, Shell), Versatic acid glycidyl ester, ethylhexyl glycidyl ether, butyl glycidyl ether, Polypox R 16 (pentaerythritol tetraglycidyl ether, UPPC AG), other Polypox grades containing free epoxy groups, Vestagon EP HA 320 (hydroxyalkyl amide, Degussa AG), and also phenylenebisoxazoline, 2-methyl-2-oxazoline, 2-hydroxyethyl-2-oxazoline, 2-hydroxypropyl-2-oxazoline, 5-hydroxypentyl-2-oxazoline, calcium hydroxide, barium hydroxide, sodium carbonate, and calcium carbonate. It will be appreciated that mixtures of such substances are also suitable. These reactive compounds can be employed in weight fractions of from 0.1% to 5%, preferably from 0.5% to 3%, based on the total formulation.

The compounds E) are monomeric monofunctional alcohols and/or monomeric mono- or difunctional amines. Suitable examples include methanol, ethanol, n-propanol, isopropanol, n-butanol, isobutanol, sec-butanol, the isomeric pentanols, hexanols, octanols, and nonanols, n-decanol, n-dodecanol, n-tetradecanol, n-hexadecanol, n-octadecanol, cyclohexanol, the isomeric methylcyclohexanols, and hydroxymethylcyclohexane, and also dimethylamine, ethylamine, diethylamine, propylamine, dipropylamine, butylamine, dibutylamine, hexylamine, dihexylamine, ethylenediamine, propylenediamine, butylenediamine, and hexamethylenediamine. Such substances E) are used in an amount from 0 to 10% by weight, based on the total formulation.

Suitable solvents under F) include all liquid substances which do not react with other ingredients; examples include acetone, ethyl acetate, butyl acetate, xylene, Solvesso 100, Solvesso 150, methoxypropyl acetate, and Dibasic ester. Component F) may vary between 0 and 70% by weight, based on the total formulation.

Additives G), such as flow control agents, polysilicones or acrylates for example, light stabilizers, sterically hindered amines for example, or other auxiliaries, as described for example in EP 0 669 353, can be added in a total amount of from 0.05% to 5% by weight. Fillers and pigments, such as titanium dioxide, can be added in an amount of up to 50% by weight of the total composition.

If solvents or water are employed then all of the constituents can be jointly dissolved or dispersed in a suitable apparatus (e.g. stirred tank, Dispermat), after which the formulation is ready for use.

Application may then take place by typical methods, such as spraying, injecting, rolling, pouring, knifecoating or other. Curing then takes place at a temperature from 120 to 220° C. for from 4 to 60 minutes, preferably at from 120 to 180° C. for from 6 to 30 minutes.

Where no solvent or water is used and the ingredients are solid, the formulation is appropriately processed as a powder coating. For that purpose, all of the constituents for producing a powder coating composition can be homogenized in suitable apparatus, such as heatable kneading assemblies, for example, but preferably by extrusion, in the course of which upper temperature limits of from 120 to 130° C. ought not to be exceeded. The extruded mass, after it has been cooled to room temperature and appropriately comminuted, is ground to give the ready-to-spray powder. This powder can be applied to appropriate substrates by the known methods, such as by electrostatic powder spraying, fluid-bed sintering or electrostatic fluid-bed sintering, for example. Following powder application, the coated workpieces are cured by heating to a temperature from 120 to 220° C. for from 4 to 60 minutes, preferably at from 120 to 180° C. for from 6 to 30 minutes.

The invention additionally provides for the use of a mixture of
A) at least one blocked aromatic, aliphatic, (cyclo)aliphatic and/or cycloaliphatic polyisocyanate component;
B) at least one monomeric, oligomeric and/or polymeric polyol;
C) at least one quaternary ammonium salt that contains a hydroxide, a fluoride or a carboxylate as counterion, in a concentration of from 0.001% to 3%, based on the total amount of the formulation;
D) at least one acid scavenger, in a concentration of from 0.1% to 5%, based on the total amount of the formulation;
E) optionally further monoalcohols, monoamines or diamines;
F) optionally solvents and/or water;
G) optionally further auxiliaries and additives
   as metal-free one-component polyurethane systems, and also the coatings.

The subject matter of the invention is illustrated below by reference to examples.

### EXAMPLES

| Ingredients | Product description, manufacturer |
|---|---|
| VESTAGON B 1613 | Triazole-blocked polyisocyanate, total |
| | NCO content: 14.5%-15.0%; DEGUSSA AG |
| ALFTALAT AN 739 | OH polyester, OH number: 55-60; AN: 2-6; UCB |
| DBTL | Dibutyltin dilaurate, Aldrich |
| Tetraethylammonium | Fluka |
| benzoate (TEAB) | |
| ARALDIT PT 912 | Glycidyl ester, Huntsman |
| KRONOS 2160 | Titanium dioxide, Kronos |
| RESIFLOW PV 88 | Flow control agent, Worlee-Chemie |

### General Production Procedure for Powder Coating Materials

The ground products—polyisocyanate compound of the invention, polyester, acid scavenger, catalyst, flow control agent, and white pigment—are intimately mixed in an edge runner mill and the mixture is then homogenized in an extruder at from 80 to 140° C. After cooling, extrudate is fractionated and ground to a particle size<100 μm using a pinned-disc mill. The powder thus produced is applied to degreased and optionally pretreated iron panels using an electrostatic powder spraying unit at 60 kV, and the coated panels are baked in a forced-air drying cabinet at from 130 to 150° C. for 30 minutes.

### Powder Coating Formulation: Composition

All powder coating formulations contained 1% Resiflow PV 88 and 30% titanium dioxide.

| Composition | 1 | A* | B* |
|---|---|---|---|
| B 1613 | 21.78 | 21.84 | 22.69 |
| AN 739 | 44.45 | 44.89 | 46.31 |
| PT 912 | 2.27 | 2.27 | — |
| TEAB | 0.5 | — | — |

*noninventive, comparative examples

### Coating Results:

| | No. | | | | | | | | |
|---|---|---|---|---|---|---|---|---|---|
| | 1 | | | A* | | | B* | | |
| Curing 30 min/[° C.] | 150 | 140 | 130 | 150 | 140 | 130 | 150 | 140 | 130 |
| Erichsen cupping [mm] | 10 | 10 | 10 | 10 | 10 | 10 | 10 | 10 | 0.5 |
| Ball impact (dir.) [in*lb] | 130 | 120 | 80 | 150 | 120 | 20 | 100 | 100 | <10 |
| Ball impact (indir.) [in*lb] | 140 | 120 | 60 | 160 | 120 | <10 | 80 | 50 | <10 |

*noninventive, comparative examples

Only in the inventive example 1 are both the Erichsen cupping and the ball impact sufficient even at 130° C.

1: A one-component polyurethane system containing the mixture of
A) at least one blocked aromatic, aliphatic, (cyclo)aliphatic and/or cycloaliphatic polyisocyanate component;
B) at least one monomeric, oligomeric and/or polymeric polyol;
C) at least one quaternary ammonium salt that contains a hydroxide, a fluoride or a carboxylate as counterion, in a concentration of from 0.001% to 3%, based on the total amount of the formulation;
D) at least one acid scavenger, in a concentration of from 0.1% to 5%, based on the total amount of the formulation;
E) optionally further monoalcohols, monoamines or diamines;
F) optionally solvents and/or water; and
G) optionally further auxiliaries and additives.

2. The one-component polyurethane system according to claim 1,
characterized in that
polyisocyanate component A) is prepared using diisocyanates of aromatic, aliphatic, and (cyclo)aliphatic and/or cycloaliphatic structure.

3. The one-component polyurethane system according to claim 2,
characterized in that polyisocyanate component A) is selected from the group consisting of
isophorone diisocyanate (IPDI), hexamethylene diisocyanate (HDI), diisocyanato-dicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), toluidine diisocyanate (TDI), methylenediphenyl diisocyanate (MDI) and tetramethylxylylene diisocyanate (TMXDI).

4. The one-component polyurethane system according to claim 3,
characterized in that
IPDI, HDI, and H₁₂MDI are used.

5. The one-component polyurethane system according to claim 1,
characterized in that
the polyisocyanate component A) is chain-extended with polyols prior to blocking.

6. The one-component polyurethane system according to claim 1,
characterized in that the blocking agent is selected from the group consisting of
methyl ethyl ketoxime, acetone oxime, phenol or a phenol derivative, ε caprolactam, 1,2,4-triazole, 2,5-dimethylpyrazole, diethyl malonate, ethyl acetoacetate, N-tert-butyl-N-benzylamine and diisopropylamine.

7. The one-component polyurethane system according to claim 1,
characterized in that polyol B) is selected from the group consisting of
ethylene glycol, triethylene glycol, butane-1,4-diol, pentane-1,5-diol, hexane-1,6-diol, 3-methylpentane-1,5-diol, neopentyl glycol, 2,2,4(2,4,4)-trimethylhexanediol and neopentyl glycol hydroxypivalate, alone or in a mixture.

8. The one-component polyurethane system according to claim 1,
characterized in that polyol B) is selected from the group consisting of
trimethylolpropane, ditrimethylolpropane, trimethylolethane, hexane-1,2,6-triol, butane-1,2,4-triol, tris(β-hydroxyethyl)isocyanurate, pentaerythritol, mannitol and sorbitol.

9. The one-component polyurethane system according to claim 1,
characterized in that polyol B) is selected from the group consisting of
a polyester, polycarbonate, polycaprolactone, polyether, polythioether, polyesteramide, polyurethane and polyacetal.

10. The one-component polyurethane system according to claim 1,
characterized in that catalyst C) is selected from the group consisting of
tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate or tetrabutylammonium benzoate, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride and benzyltrimethylammonium fluoride.

11. The one-component polyurethane system according to claim 1,
characterized in that the acid-scavenging compound D) is selected from the group consisting of
an epoxy compound, a carbodiimide, a hydroxyalkyl amide, 2-oxazoline, and an inorganic hydroxide, hydrogencarbonate or carbonate salt.

12. The one-component polyurethane system according to claim 1,
characterized in that the acid-scavenging compound D) is selected from the group consisting of
triglycidyl ether isocyanurate (TGIC), EPIKOTE® 828 (diglycidyl ether based on bisphenol A, Shell), Versatic acid glycidyl ester, ethylhexyl glycidyl ether, butyl glycidyl ether, Polypox R 16 (pentaerythritol tetraglycidyl ether, UPPC AG), other Polypox grades containing free epoxy groups, Vestagon EP HA 320 (hydroxyalkyl amide, Degussa AG), phenylenebisoxazoline, 2-methyl-2-oxazoline, 2 hydroxyethyl-2-oxazoline, 2-hydroxypropyl-2-oxazoline, 5-hydroxypentyl-2-oxazoline, calcium hydroxide, barium hydroxide, sodium carbonate and calcium carbonate.

13. The one-component polyurethane system according to claim 1,
characterized in that compound E) is selected from the group consisting of
methanol, ethanol, n-propanol, isopropanol, n-butanol, isobutanol, sec-butanol, an isomeric pentanol, hexanol, octanol or nonanol, n-decanol, n dodecanol, n-tetradecanol, n-hexadecanol, n-octadecanol, cyclohexanol, an isomeric methylcyclohexanol or hydroxymethylcyclohexane, dimethylamine, ethylamine, diethylamine, propylamine, dipropylamine, butylamine, dibutylamine, hexylamine, dihexylamine, ethylenediamine, propylenediamine, butylenediamine and hexamethylenediamine.

14. The one-component polyurethane system according to claim 1,
characterized in that solvent F) is selected from the group consisting of
acetone, ethyl acetate, butyl acetate, xylene, Solvesso 100, Solvesso 150, methoxypropyl acetate and Dibasic ester.

15. A metal-free one-component polyurethane system comprising a mixture of
A) at least one blocked aromatic, aliphatic, (cyclo)aliphatic and/or cycloaliphatic polyisocyanate component;
B) at least one monomeric, oligomeric and/or polymeric polyol;
C) at least one quaternary ammonium salt that contains a hydroxide, a fluoride or a carboxylate as counterion, in a concentration of from 0.001% to 3%, based on the total amount of the formulation;
D) at least one acid scavenger, in a concentration of from 0.1% to 5%, based on the total amount of the formulation;
E) optionally further monoalcohols, monoamines or diamines;
F) optionally solvents and/or water; and
G) optionally further auxiliaries and additives.

16. A coating containing
A) at least one blocked aromatic, aliphatic, (cyclo)aliphatic and/or cycloaliphatic polyisocyanate component;
B) at least one monomeric, oligomeric and/or polymeric polyol;
C) at least one quaternary ammonium salt that contains a hydroxide, a fluoride or a carboxylate as counterion, in a concentration of from 0.001% to 3%, based on the total amount of the formulation;
D) at least one acid scavenger, in a concentration of from 0.1% to 5%, based on the total amount of the formulation;
E) optionally further monoalcohols, monoamines or diamines;
F) optionally solvent and/or water; and
G) optionally further auxiliaries and additives.
